(19) United States
(12) Patent Application Publication
(10) Pub. No.: US 2012/0163148 A1
(43) Pub. Date: Jun. 28, 2012

(54) SYNCHRONIZATION DETECTING METHOD AND SYNCHRONIZATION DETECTING CIRCUIT

(75) Inventor: Hiroyuki SHIN-E, Kanagawa (JP)

(73) Assignee: NEC Electronics Corporation

(21) Appl. No.: 13/410,967

(22) Filed: Mar. 2, 2012

Related U.S. Application Data
(62) Division of application No. 12/382,854, filed on Mar. 25, 2009.

(30) Foreign Application Priority Data
Apr. 28, 2008 (JP) 2008-117081

(51) Int. Cl. G11B 20/10

(52) U.S. Cl. 369/59.19; G9B/20.009

(57) ABSTRACT

A synchronization detecting circuit detects a synchronous signal from a reproduced signal of a recording medium in which a random shift method is employed. A window generator in the synchronization detecting circuit generates a third window having as a central phase one predicted phase in a second predicted coordinate that is obtained by replicating a first predicted coordinate indicating a predicted phase of each synchronous signal that repeatedly appears in the reproduced signal and having a phase width equivalent to twice a random shift width when the synchronous signal is not detected using a first window after the synchronous signal is detected using a second window by a synchronization detector.

### CROSS REFERENCE TO RELATED APPLICATIONS

This application is a divisional of U.S. application Ser. No. 12/382,854, filed Mar. 25, 2009, which claims benefit of priority from the prior Japanese Application No. 2008-117081, filed on Apr. 28, 2008; the entire contents of all of which are incorporated herein by reference.

### FIELD OF THE INVENTION

The present invention relates to a synchronization detecting method and a synchronization detecting circuit, and more particularly, to a method and a circuit for detecting a synchronous signal from a reproduced signal of a recording medium in which a method is employed of randomly shifting a start position for recording data within a certain width with respect to a predetermined recording reference position every time the data is recorded (hereinafter referred to as random shift method).

### DESCRIPTION OF RELATED ART

In general, recording reference positions are arranged with certain intervals on a recording medium in which the random shift method is employed corresponding to a block length of a data block to be recorded. In recording the data, random shift is performed in order to avoid wear of the medium caused by repeated recordings.

More specifically, assume a case of rewriting data DT2 on DT1 which has already been recorded on a recording medium as shown in FIG. 9. A recording start position SP of the data DT2 is determined within a random shift width RS with respect to a recording reference position RP to record the data DT2. Now, the random shift width RS is formed of detection error ranges ER1 and ER2 shown before and after the recording reference position RP, and recording start position shift ranges SR1 and SR2 shown outside of the ranges ER1 and ER2. Further, the ranges ER1 and ER2 are arranged in consideration of the detection error (deviation) of the recording reference position RP from the recording medium by a recording device.

The recording medium in which the random shift method is employed includes HD DVD-R (High Density DVD Recordable Disc), HD DVD-RW (High Density DVD Re-recordable Disc), BD-R (Blu-ray Disc Recordable Format), BD-RW (Blu-ray Disc Rewritable Format), and so on. In the following description, the HD DVD-R and the HD DVD-RW arc collectively referred to as HD DVD, and the BD-R and the BD-RW as BD.

Hereinafter, the format example of the recorded data DT in the HD DVD and BD will be described with reference to FIGS. 10A to 10G and FIGS. 11A to 11E, respectively.

First, the recorded data DT in the HD DVD is, as shown in FIG. 10A, formed of one or more data segments DS, and a guard field F6 added at the end of the recording. The data segment DS is formed of a VFO (Variable Frequency Oscillator) field F1 as a header area used, for example, in drawing phase or frequency by a PLL (Phase Locked Loop) circuit or the like, a data field F2 as a data area, a postamble field F3 as a footer area, a reserve field F4, and a buffer field F5.

The VFO field F1 is an area of 852 cbs (channel bits) where a fixed pattern FPTN1=“0100” is repeatedly stored for 213 times as shown in FIG. 10B.

The data field F2 is an area of 928512 cbs where 26 frames FR0 to FR25 (hereinafter collectively referred also to as symbol FR) are repeatedly stored for 32 times as shown in FIG. 10C. Further, each of the frames FR0 to FR25 stores synchronous data SD of 24 cbs formed of a synchronization pattern PTN and synchronization positional information INF, and user data UD of 1092 cbs.

The postamble field F3 is an area of 24 cbs storing synchronous data SD as shown in FIG. 10D. The reserve field F4 is an area of 48 cbs storing the user data UD as shown in FIG. 10E. The buffer field F5 is an area of 192 cbs where the fixed pattern FPTN1 is repeatedly stored for 48 times as shown in FIG. 10F.

The guard field F6 is an area of 288 cbs repeatedly storing the fixed pattern FPTN1 for 72 times as shown in FIG. 10G.

Next, the recorded data DT in the BD is, as shown in FIG. 11A, formed of one or more recording unit blocks RUB and a guard area A4 added to the end of the recording. The recording unit block RUB is formed of a run-in area A1 as a header area, a physical cluster area A2 as a data area, and a run-out area A3 as a footer area.

The run-in area A1 is an area of 2760 cbs storing 132 fixed patterns FPTN2=“01001001010100001000”, synchronous data SD of 30 cbs, two fixed patterns FPTN2, synchronous data SD, and fixed pattern FPTN2 in this order as shown in FIG. 11B. The synchronous data SD is formed of a synchronization pattern PTN and synchronization positional information INF.

The physical cluster area A2 is an area of 958272 cbs repeatedly storing 31 frames FR0 to FR30 for 16 times as shown in FIG. 11C. Further, each of the frames FR0 to FR30 stores synchronous data SD, and user data UD of 1902 cbs.

The run-out area A3 is an area of 1104 cbs repeatedly storing synchronous data SD, fixed pattern FPTN3=“0100000000 . . . 1000000”, and 24 fixed patterns FPTN2 in this order.

The guard area A4 is an area of 540 cbs storing the fixed pattern FPTN2 for 27 times.

As described above, the recorded data DT in the HD DVD may be formed of one data segment DS. Thus, in reproducing the HD DVD, the synchronization detection needs to be executed in consideration of the probability that the random shift is executed for each data segment DS. Similarly, in reproducing the BD, the synchronization detection needs to be executed in consideration of the probability that the random shift is executed for each recording unit block RUB.

The typical configuration example and the operation example of the synchronization detecting circuit addressing it will be described with reference to FIGS. 12 to 15.

A synchronization detecting circuit 1 shown in FIG. 12 includes a window generator 10, a synchronization detector 20, a predicted coordinate generator 30, and a controller 40. The window generator 10 alternatively generates a window W1 or W2 used for performing the synchronization detection from a reproduced signal RF of HD-DVD or BD. The synchronization detector 20 sequentially detects synchronous signals (synchronous data SD) that appear repeatedly in the reproduced signal RF using the windows W1 and W2 to output a synchronization detection signal SS, and obtains synchronization positional information INF included in the synchronous data SD and the user data UD that follows the synchronous data SD. The predicted coordinate generator 30 generates a predicted coordinate C1 showing a predicted phase of each synchronous data that is to be subsequently appeared based on periodicity of the synchronous data SD every time the predicted coordinate generator 30 receives the synchronization detection signal SS. The controller 40 outputs a signal for the window generator 10 to select the window W1 or W2 (hereinafter referred to as window selection signal) SG1, and a signal for allowing the generation of the window W2 (hereinafter referred to as W2 generation enable signal) SG2 based on the synchronization positional information INF and the user data UD. Note that the window means the pulse signal used in detecting the synchronization pattern of the synchronous signal included in the reproduced signal RF by pattern matching.

Now, the window W2 is used to detect the data field F2 shown in FIG. 10C, or the leading synchronous data included in the physical cluster area A2 shown in FIG. 11C. The window W1 is used to detect the synchronous data other than the leading synchronous data. Note that the window is opened only in a period including a certain time before and after the timing at which the appearance of the synchronous data SD is predicted (predicted phase in the predicted coordinate C1) in order leadingrevent false detection of the synchronous data caused by bit error due to scratch, dust or the like on the recording medium.

Further, the predicted coordinate C1 is generated or regenerated every time the predicted coordinate generator 30 receives the synchronization detection signal SS because the phase interval at which the synchronous data SD is appeared varies at the boundary of the recorded data along with the execution of the random shift.

Further, the synchronization detector 20 includes a synchronization pattern detector 21 and a demodulator 22. The synchronization pattern detector 21 executes detection of the synchronization pattern PTN from the reproduced signal RF using the window W1 or W2, output of the synchronization detection signal SS, extraction of the synchronization positional information INF, extraction of the user data UD modulated in recording, and parallel output of the extracted user data UD. The demodulator 22 demodulates parallel data PD outputted from the detector 21 to obtain the user data (demodulated data) UD.

Note that the user data UD outputted from the demodulator 22 is supplied to the controller 40 and to the subsequent error correcting circuit (not shown). Further, each part in the synchronization detecting circuit 1 operates by a reproducing clock (not shown) generated by the former PLL circuit (not shown) or the like.

Next, the operation of the synchronization detecting circuit 1 shown in FIG. 12 will be described with reference to FIGS. 13 to 15. In the operation of the initial state (not shown), when detecting the synchronization pattern PTN from the reproduced signal RF for a predetermined number of times with the window W1 being fully opened (always in ON state), the synchronization pattern detector 21 supplies the synchronization detection signal SS to each of the predicted coordinate generator 30 and the window generator 10, so that the predicted coordinate generator 30 and the window generator 10 generate the predicted coordinate C1 and the window W1, respectively.

Assume a case in which the reproduced signal RF is obtained by sequentially reproducing the recorded data DT1 and DT2 recorded in the HD-DVD as shown in FIG. 13. Then, the window generator 10 generates a window W1[1] (window having phase width of “2”, in this example) with a center of a predicted phase P1 (phase “0”) in the predicted coordinate C1 to supply the window W1[1] to the synchronization pattern detector 21. The phase that is decreased from “−c(−12)” to “0” after increasing from “0” to “b(11)” is repeatedly shown in the predicted coordinate C1 shown in FIG. 13. The phase interval between adjacent phases “0” is accorded with the phase width when the frame FR shown in FIG. 10C is reproduced.

Then, the synchronization pattern detector 21 detects the synchronization pattern PTN1 included in the data field F2 in the recorded data DT1 using the window W1[1], and supplies the synchronization detection signal SS1 to each of the predicted coordinate generator 30 and the window generator 10. Further, the synchronization pattern detector 21 extracts the synchronization positional information INF that follows the synchronization pattern PTN1, to supply the synchronization positional information INF to the controller 40, and extracts the user data UD that follows the synchronization positional information INF to make the demodulator 22 perform the demodulation.

Upon receiving the synchronization detection signal SS1, the window generator 10 closes (lowers) the window W1[1]. Further, the predicted coordinate generator 30 regenerates (resets) the predicted coordinate C1 to be supplied to the window generator 10.

Then, the window generator 10 generates a window W1[2] having as a central phase a predicted phase P2 in the predicted coordinate C1 that is regenerated to supply the window W1[2] to the synchronization pattern detector 21. If it is assumed that the above-described synchronization pattern PTN1 is the final synchronization pattern included in the data field F2, the synchronization pattern detector 21 detects the synchronization pattern PTN2 included in the postamble field F3 in the recorded data DT1 using the window W1[2].

If the synchronization pattern PTN2 has been changed to a pattern other than the synchronization pattern due to the bit error, the synchronization pattern detector 21 neither detects the synchronization pattern PTN2 nor outputs a synchronization detection signal SS2. In this case, the window generator 10 closes the window W1[2] based on the phase value (“1”) in the predicted coordinate C1. Further, the predicted coordinate generator 30 does not execute the regeneration of the predicted coordinate C1.

However, the controller 40 is able to identify which of the frames FR0 to FR3 in the data field F2 is reproduced by the reproduced signal RF based on the above-described synchronization positional information INF, and to identify whether the reproduced signal RF reproduces the final frame FR in the data field F2 based on address information or the like included in the user data UD. Accordingly, the controller 40 determines that the synchronization pattern that is to be detected next is the leading synchronization pattern included in the data field F2 in the recorded data DT2, and raises the window selection signal SG1 and the W2 generation enable signal SG2, so as to make the window generator 10 generate the window W2 having as a central phase a predicted phase P3 in the predicted coordinate C1.

The central phase of the window W2 is set to the predicted phase P3 which is apart from the predicted phase P2 by the phase width equivalent to one frame because the total field length (1116 cbs) of the VFO field F1 and the postamble field F3 to the buffer field F5 is equal to the frame length (1116 cbs) of the frame FR. When the recorded data DT1 and DT2 are recorded with the same random shift amount (namely, when the recorded data DT1 and DT2 are sequentially recorded at the same recording timing), the leading synchronization pattern included in the data field F2 in the recorded data DT2 is detected at the predicted phase P3.

On the other hand, considering a case where the recorded data DT2 is rewritten after the recorded data DT1 with different random shift amount, the window generator 10 generates the window W2 having the predicted phase P3 as the central phase and having the phase width “20” which is twice as large as the phase width (hereinafter referred to as random shift phase width, and the phase width is set to “10”) SW equivalent to the random shift width RS shown in FIG. 9, so as to supply the window W2 to the synchronization pattern detector 21.

The phase width of the window W2 is set twice as large as the random shift phase width SW in order to satisfy the following conditions (1) and (2).

### Condition (1)

Assume a case where the predicted phase P3 is a phase that is obtained as a result of shifting the recording start position SP of the recorded data DT1 to the right end of the recording start position shift range SR1 with respect to the recording reference position RP. In this case, as the recording reference position SP is arranged with a certain interval on the recording medium, the leading synchronization pattern included in the data field F2 in the recorded data DT2 can be detected within the random shift phase width SW with a center of phase of the recording reference position that is relatively estimated from the predicted phase P3 (hereinafter referred to as estimated phase) PP1 without fail.

### Condition (2)

Assume a case where the predicted phase P3 is a phase that is obtained as a result of shifting the recording start position SP of the recorded data DT1 to the left end of the recording start position shift range SR2 with respect to the recording reference position RP. In this case, as the recording reference position SP is arranged with the certain interval on the recording medium, the leading synchronization pattern included in the data field F2 in the recorded data DT2 can be detected within the random shift phase width SW with a center of estimated phase PP2 of the recording reference position without fail.

Then, the synchronization pattern detector 21 detects the leading synchronization pattern PTN3 included in the data field F2 in the recorded data DT2 using the window W2, and supplies a synchronization detection signal SS3 to each of the predicted coordinate generator 30 and the window generator 10. Further, the synchronization pattern detector 21 extracts the synchronization positional information INF following the synchronization pattern PTN3 to supply the synchronization positional information INF to the controller 40, and extracts the user data UD following the synchronization positional information INF to make the demodulator 22 perform the demodulation.

Upon receiving the synchronization detection signal SS3, the window generator 10 closes the window W2. Further, the predicted coordinate generator 30 regenerates the predicted coordinate C1 to be supplied to the window generator 10. Further, the controller 40 determines that the synchronization pattern which is to be detected next is not the leading synchronization pattern included in the data field in the following recorded data (not shown) based on the synchronization positional information INF and the user data UD, so as to lower the window selection signal SG1 and the W2 generation enable signal SG2.

As such, the window generator 10 generates a window W1[3] having as a central phase a predicted phase P4 in the predicted coordinate C1 which is regenerated to supply the window W1[3] to the synchronization pattern detector 21. The synchronization pattern detector 21 detects the synchronization pattern PTN4 next to the synchronization pattern PTN3 using the window W1[3].

Hereinafter, by repeatedly executing the above operation, the synchronization detecting circuit 1 is able to obtain the user data and perform the normal synchronization detection from the reproduced signal of the HD DVD (see Japanese Unexamined Patent Application Publication No. 2002-329329 (Nagata et al.), for example).

Further, as shown in FIG. 14, take a case where the reproduced signal RF is obtained by sequentially reproducing the recorded data DT1 and DT2 recorded in the BD as an example. In this case, the window generator 10 generates the window W1[2] having as a central phase the predicted phase P2 in the predicted coordinate C1 to supply the window W1[2] to the synchronization pattern detector 21.

If it is assumed that the synchronization pattern PTN2 is normally recorded and reproduced, the synchronization pattern detector 21 detects the synchronization pattern PTN2 and supplies the synchronization detection signal SS2 to each of the predicted coordinate generator 30 and the window generator 10. Further, the synchronization pattern detector 21 extracts the synchronization positional information INF following the synchronization pattern PTN2 to supply it to the controller 40, and extracts the user data UD following the synchronization positional information INF to make the demodulator 22 perform the demodulation.

Upon receiving the synchronization detection signal SS2, the window generator 10 closes the window W1[2]. Further, the predicted coordinate generator 30 regenerates the predicted coordinate C1 to be supplied to the window generator 10. Furthermore, the controller 40 determines that the synchronization pattern which is to be detected next is the leading synchronization pattern included in the physical cluster area A2 in the following recorded data DT2 based on the synchronization positional information INF and the user data UD. At this time, the controller 40 raises the window selection signal SG1 as is similar to when the HD DVD is reproduced. On the other hand, the controller 40 raises the W2 generation enable signal SG2 so as to generate the window W2 having as the central phase the predicted phase P4 in the predicted coordinate C1, as is different from when the HD DVD is reproduced.

The central phase of the window W2 is set to the predicted phase P4 which is apart from the predicted phase P2 by the phase width equivalent to two frames because the total area length (3864 cbs) of the run-out area A3 and the run-in area A1 respectively shown in FIGS. 11B and 11D is equal to the frame length of two frames of the frame FR (1932 cbs×2). When the recorded data DT1 and DT2 are recorded with the same random shift amount, the leading synchronization pattern included in the physical cluster area A2 in the recorded data DT2 is detected at the predicted phase P4.

Further, the window generator 10 generates the window W2 having as the central phase the predicted phase P4 and having the phase width which is twice as large as the random shift phase width SW, so as to supply the window W2 to the synchronization pattern detector 21, as is similar to when the HD DVD is reproduced.

Then, the synchronization pattern detector 21 detects a leading synchronization pattern PTN3 included in the physical cluster area A2 in the recorded data DT2 using the window W2, and supplies a synchronization detection signal SS3 to the predicted coordinate generator 30 and the window generator 10.

The synchronization pattern PTN3 and two synchronization patterns PTNα and PTNβ included in the run-in area A1 exist in the window W2, as shown in FIG. 14. Accordingly, the synchronization pattern detector 21 executes the pattern matching shown in FIG. 15 to detect the synchronization pattern PTNβ. More specifically, the synchronization pattern detector 21 first detects the synchronization pattern PTNα using matching pattern MPTN1α or MPTN2α which is preset so as to match a part of the synchronization pattern PTNα in synchronization with the reproducing clock CLK. Next, the synchronization pattern detector 21 detects the synchronization pattern PTNβ using matching pattern MPTN1β or MPTN2β which is preset so as to match a part of the synchronization pattern PTNβ. Lastly, the synchronization pattern detector 21 detects the synchronization pattern PTN3 using matching pattern MPTN13 or MPTN23 which is preset so as to match a part of the synchronization pattern PTN3. As a result, when all of the synchronization patterns PTNα, PTNβ, and PTN3 are detected, the synchronization pattern detector 21 supplies the synchronization detection signal SS3 to each of the predicted coordinate generator 30 and the window generator 10.

It should be noted that the matching patterns MPTN2β and MPTN23 have lower threshold value for synchronization pattern detection compared with the matching patterns MPTN1β and MPTN13, respectively. When these matching patterns MPTN2β and MPTN23 are used, the matching probability (synchronization detection probability) can be made higher. On the other hand, when using the matching patterns MPTN1β and MPTN13, the synchronization false detection probability can be made lower.

Further, the synchronization pattern detector 21 extracts the synchronization positional information INF following the synchronization pattern PTN3 to supply it to the controller 40, and extracts the user data UD following the synchronization positional information INF to make the demodulator 22 perform the demodulation.

Upon receiving the synchronization detection signal SS3, the window generator 10 closes the window W2. Further, the predicted coordinate generator 30 regenerates the predicted coordinate C1 to be supplied to the window generator 10. Further, the controller 40 determines that the synchronization pattern which is to be detected next is not the leading synchronization pattern included in the physical cluster area in the following recorded data (not shown) based on the synchronization positional information INF and the user data UD. Then, the controller 40 lowers the window selection signal SG1 and the W2 generation enable signal SG2.

Accordingly, the window generator 10 generates a window W1[3] having as a central phase a predicted phase P5 in the predicted coordinate C1 which is regenerated to supply the window W1[3] to the synchronization pattern detector 21. The synchronization pattern detector 21 detects the synchronization pattern PTN4 next to the synchronization pattern PTN3 using the window W1[3].

Hereinafter, by repeatedly executing the above operation, the synchronization detecting circuit 1 is able to obtain the user data and perform the normal synchronization detection from the reproduced signal of the BD.

### SUMMARY

However, the present inventors have found a problem as follows. That is, the burst error is caused in the above-described synchronization detecting circuit 1 when there is a synchronization pattern which should not exist in the window W2 due to the bit error or the like.

More specifically, when there is included in the window W2 generated with a center of the predicted phase P3 the normal synchronization pattern PTN3, and an abnormal synchronization pattern PTNγ caused by the bit error due to scratch, dust or the like on the HD DVD or BD as shown in FIG. 16, the synchronization detecting circuit 1 falsely detects the synchronization pattern PTNγ as the normal synchronization pattern to generate a synchronization detection signal SSγ, and closes the window W2. Accordingly, the regeneration of the predicted coordinate C1 is performed, and the synchronization pattern PTN3 is not detected.

Accordingly, even when the window W1[3] with a center of the predicted phase P4 in the predicted coordinate C1 which is regenerated is used, the synchronization pattern PTN4 which should be detected is not detected. Further, even when a window W1[4] having as a central phase the predicted phase P5 and having a phase width which is twice as large as the random shift phase width SW is used, the synchronization pattern PTN5, which should be detected next to the synchronization pattern PTN4 as well as the synchronization pattern PTN4 cannot be detected.

Accordingly, the following synchronization patterns cannot be detected, and the user data cannot be normally obtained. As a result, the burst error occurs beyond the correction capability of the subsequent error correcting circuit.

A first exemplary aspect of an embodiment of the present invention is a synchronization detecting method that detects a synchronous signal using a window from a reproduced signal of a recording medium where a method is employed of randomly shifting a recording start position within a certain width with respect to a predetermined recording reference position every time one or more data blocks formed of a header area, a data area, and a footer area are recorded. This synchronization detecting method generates a first window having as a central phase each predicted phase in a first coordinate when it is determined that a synchronous signal to be detected next is not a leading synchronous signal included in a data area of one data block based on a data signal following the synchronous signal and synchronization positional information included in each synchronous signal that repeatedly appears in the reproduced signal. The synchronization detecting method generates a second coordinate obtained by replicating the first coordinate and a second window having as a central phase a first predicted phase selected from predicted phases in the second coordinate based on area length of the footer area and the header area and having a phase width equivalent to twice the certain width when it is determined that the synchronous signal to be detected next is the leading synchronous signal. The synchronization detecting method further generates a third window having as a central phase one predicted phase in the second coordinate and having a phase width equivalent to twice the certain width when the synchronous signal is not detected using the first window after the synchronous signal is detected using the second window. The first coordinate indicates a predicted phase of each synchronous signal to be subsequently appeared based on periodicity of the synchronous signal every time the synchronous signal is detected.

A second exemplary aspect of an embodiment of the present invention is a synchronization detecting circuit including a window generator that generates a window, a synchronization detector that sequentially detects synchronous signals that repeatedly appear in a reproduced signal of a recording medium where a method is employed of randomly shifting a recording start position within a certain width with respect to a predetermined recording reference position every time one or more data blocks formed of a header area, a data area, and a footer area are recorded using the window, and obtains synchronization positional information included in the synchronous signal and a data signal following the synchronous signal, a predicted coordinate generator that generates a first coordinate indicating a predicted phase of each synchronous signal to be subsequently appeared based on periodicity of the synchronous signal every time the synchronous signal is detected, and a controller that makes the window generator generate a first window having as a central phase each predicted phase in the first coordinate when it is determined that a synchronous signal to be detected next is not a leading synchronous signal included in a data area of one data block based on the synchronization positional information and the data signal, and makes the predicted coordinate generator generate a second coordinate obtained by replicating the first coordinate and makes the window generator generate a second window having as a central phase a first predicted phase selected from predicted phases in the second coordinate based on area length of the footer area and the header area and having a phase width equivalent to twice the certain width when it is determined that the synchronous signal to be detected next is the leading synchronous signal. The window generator generates a third window having as a central phase one predicted phase in the second coordinate and having a phase width equivalent to twice the certain width when the synchronous signal is not detected using the first window after the synchronous signal is detected using the second window by the synchronization detector.

According to the present invention, even when the abnormal synchronous signal as shown in FIG. 16 is detected, the window having a phase width which is twice as large as the random shift phase width can be generated using the second coordinate indicating the predicted phase of the synchronous signal which has been replicated prior to this detection of the abnormal synchronous signal. Therefore, the following synchronization patterns can be detected without fail, so that the user data can be normally obtained.

According to the present invention, the occurrence of the burst error can be avoided in the synchronization detection from the reproduced signal of the recording medium in which the random shift method is employed. Therefore, high correction capability is not needed in the error correction circuit, and the reproducing capability of the reproducing device can be greatly improved.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram showing a configuration example of a first exemplary embodiment of a synchronization detecting circuit according to the present invention;

FIG. 2 is a time chart showing an operation example when data recorded in an HD DVD is sequentially reproduced in the first exemplary embodiment of the synchronization detecting circuit according to the present invention;

FIG. 3 is a time chart showing an operation example when data recorded in a BD is sequentially reproduced in the first exemplary embodiment of the synchronization detecting circuit according to the present invention;

FIG. 4 is a time chart showing an operation example when there is an abnormal synchronization pattern in the first exemplary embodiment of the synchronization detecting circuit according to the present invention;

FIG. 5 is a block diagram showing a configuration example of a second exemplary embodiment of a synchronization detecting circuit according to the present invention;

FIGS. 6A to 6E each shows a time chart of an operation example of the second exemplary embodiment of the synchronization detecting circuit according to the present invention;

FIG. 7 is a block diagram showing a configuration example of a third exemplary embodiment of a synchronization detecting circuit according to the present invention;

FIGS. 8A to 8E each shows a time chart showing an operation example of the third exemplary embodiment of the synchronization detecting circuit according to the present invention;

FIG. 9 shows a data rewriting process in a recording medium in which a random shift method is employed;

FIGS. 10A to 10G each shows a format example of recorded data in the HD DVD;

FIGS. 11A to 11E each shows a format example of recorded data in the BD;

FIG. 12 is a block diagram showing a typical configuration example of a synchronization detecting circuit;

FIG. 13 is a time chart showing an operation example when the data recorded in the HD DVD is sequentially reproduced in the synchronization detecting circuit shown in FIG. 12;

FIG. 14 is a time chart showing an operation example when the data recorded in the BD is sequentially reproduced in the synchronization detecting circuit shown in FIG. 12;

FIG. 15 is a time chart showing a pattern matching operation example of a synchronization pattern detector employed in the synchronization detecting circuit shown in FIG. 12; and

FIG. 16 is a diagram for describing a problem of the synchronization detecting circuit shown in FIG. 12.

### DETAILED DESCRIPTION OF THE EXEMPLARY EMBODIMENTS

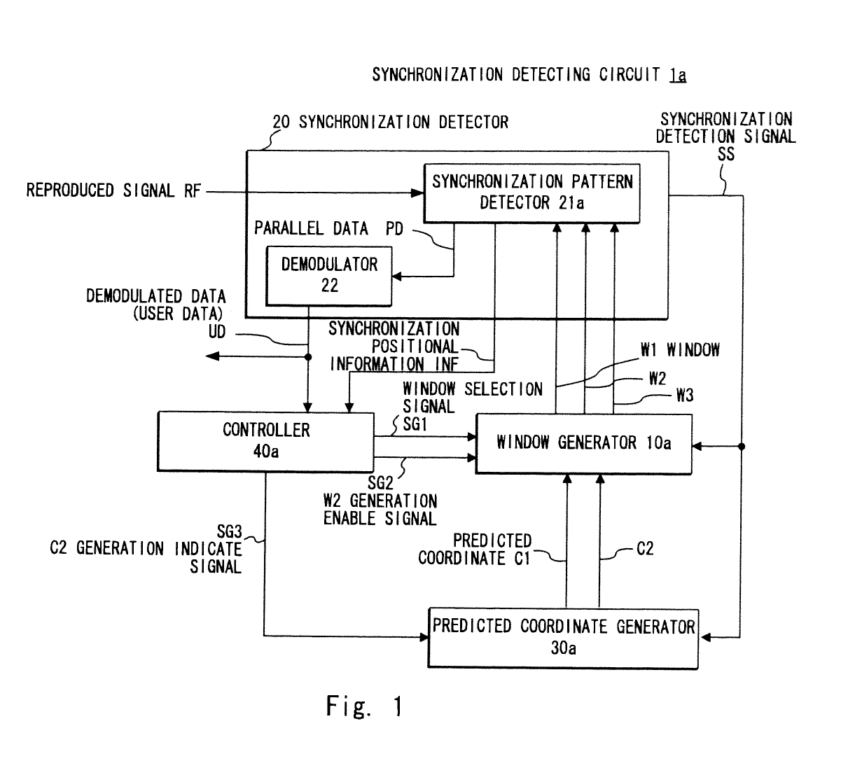

The first to third exemplary embodiments of a synchronization detecting method and a circuit using the same according to the present invention will be described with reference to FIGS. 1 to 5, 6A to 6E, 7, and 8A to 8E.

### First Exemplary Embodiment

A synchronization detecting circuit 1a according to the first exemplary embodiment shown in FIG. 1 is different from the synchronization detecting circuit 1 shown in FIG. 12 in that the synchronization detecting circuit 1a includes a window generator 10a, a synchronization pattern detector 21a, a predicted coordinate generator 30a, and a controller 40a. The window generator 10a generates a window W3 in addition to the windows W1 and W2. The synchronization pattern detector 21a uses one of the windows W1 to W3 to detect the synchronization pattern that appears in the reproduced signal RF. The predicted coordinate generator 30a generates a predicted coordinate C2 which is obtained by replicating the predicted coordinate C1 and used for generating the windows W2 and W3 in addition to the predicted coordinate C1. The controller 40a generates a signal indicating the timing of generating the predicted coordinate C2 (hereinafter referred to as C2 generation indicate signal) SG3 in addition to the window selection signal SG1 and the W2 generation enable signal SG2.

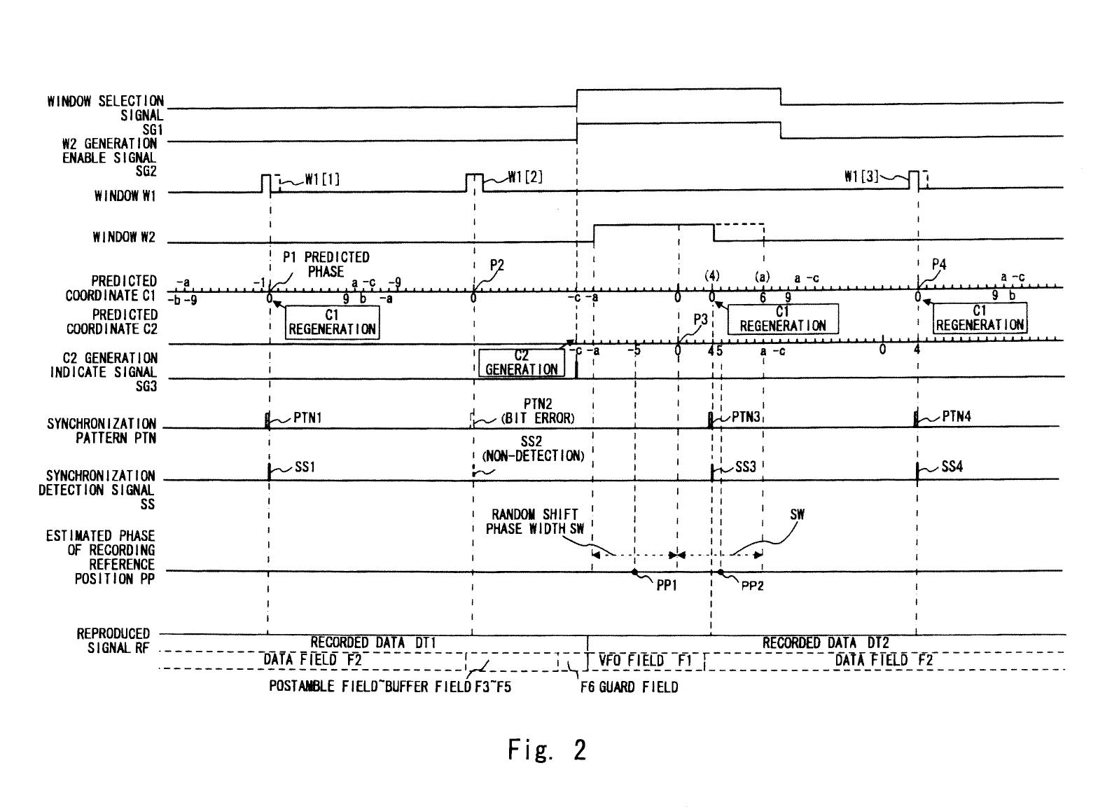

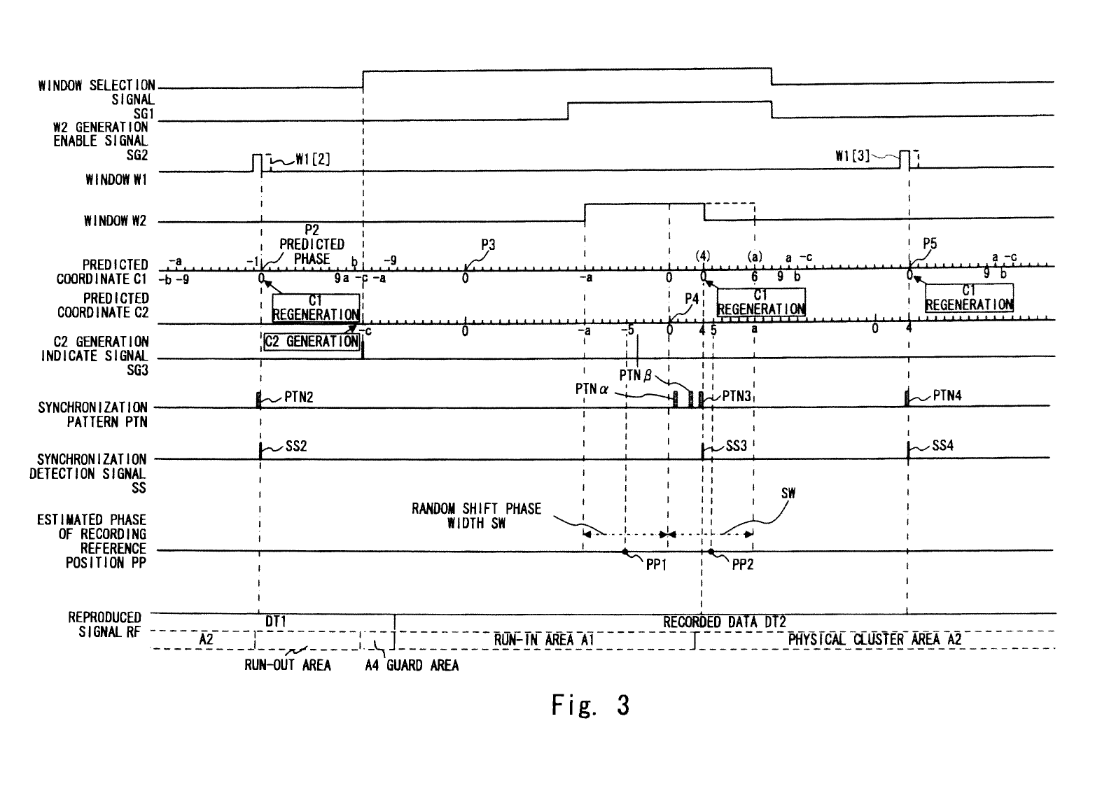

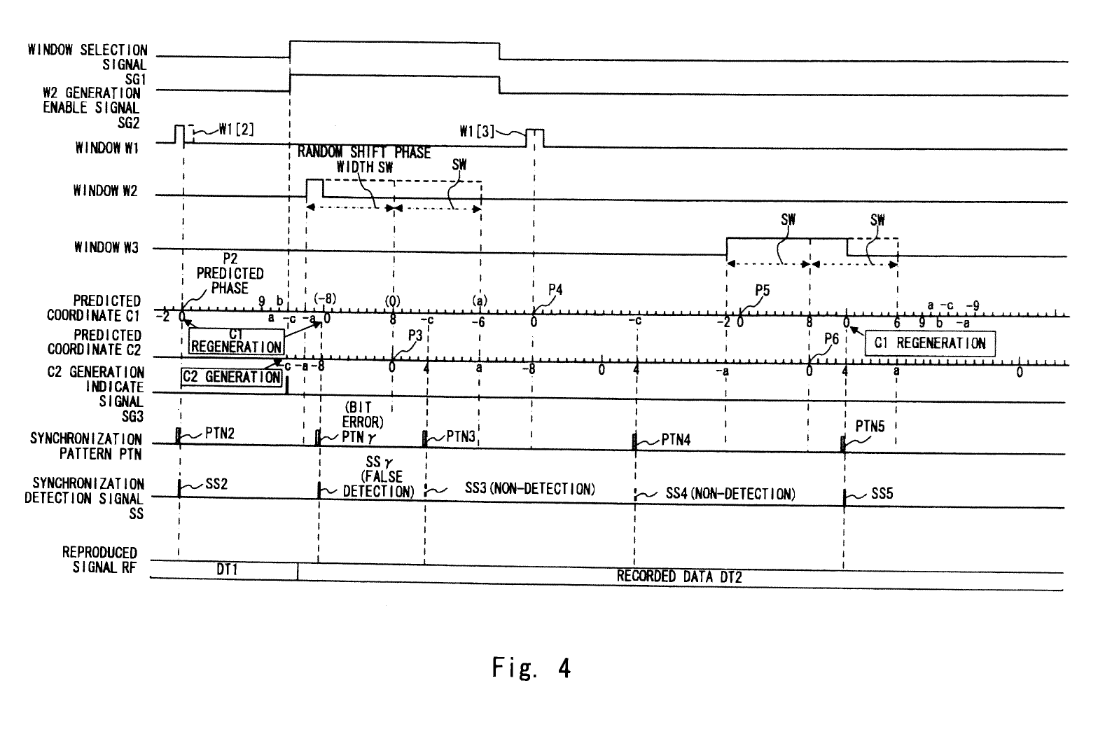

Next, the operation of the synchronization detecting circuit la shown in FIG. 1 will be described. First, the operation example (1) in a case where the reproduced signal RF is the reproduced signal of the HD DVD and the BD will be described with reference to FIGS. 2 and 3, respectively. Further, the operation example (2) in a case where abnormal synchronization pattern PTN caused by the bit error due to scratch, dust or the like on the HD DVD or BD exist in the window W2 will be described with reference to FIG. 4.

### Operation Example (1)

Assume a case in which the reproduced signal RF is obtained by sequentially reproducing the recorded data DT1 and DT2 recorded in the HD-DVD as shown in FIG. 2. In this case, the window generator 10a sequentially generates windows W1[1] and W1[2] having centers of predicted phases P1 and P2 in the predicted coordinate C1 as is similar to the window generator 10 shown in FIG. 12 to supply the windows W1[1] and W1[2] to the synchronization pattern detector 21a.

The synchronization pattern detector 21a detects the synchronization pattern PTN1 included in the data field F2 in the recorded data DT1 using the window W1[1] as is the same way as the synchronization pattern detector 21 shown in FIG. 12, so as to supply the synchronization detection signal SS1 to each of the predicted coordinate generator 30 and the window generator 10a. Further, the synchronization pattern detector 21a extracts the synchronization positional information INF that follows the synchronization pattern PTN1 to supply the synchronization positional information INF to the controller 40a, and extracts the user data UD that follows the synchronization positional information INF to make the demodulator 22 perform the demodulation.

Upon receiving the synchronization detection signal SS1, the window generator 10a closes the window W1[1] as is similar to the window generator 10 shown in FIG. 12. Further, the predicted coordinate generator 30a regenerates the predicted coordinate C1 as is similar to the predicted coordinate generator 30 shown in FIG. 12 to supply the predicted coordinate C1 to the window generator 10a.

If it is assumed that the synchronization pattern PTN1 is the final synchronization pattern included in the data field F2, the synchronization pattern detector 21 a detects the synchronization pattern PTN2 included in the postamble field F3 in the recorded data DT1 using the window W1[2]. If the synchronization pattern PTN2 has been changed to a pattern other than the synchronization pattern due to the bit error, the synchronization pattern detector 21 neither detects the synchronization pattern PTN2 nor outputs the synchronization detection signal SS2. In this case, the window generator 10a closes the window W1[2] based on the phase value (“1”) in the predicted coordinate C1 as is similar to the window generator 10 shown in FIG. 12. Further, the predicted coordinate generator 30a does not execute the regeneration of the predicted coordinate C1 as is similar to the predicted coordinate generator 30 shown in FIG. 12.

Further, the controller 40a determines that the synchronization pattern that is to be detected next is the leading synchronization pattern included in the data field F2 in the recorded data DT2 based on the synchronization positional information INF and the user data UD, and raises the window selection signal SG1 and the W2 generation enable signal SG2 as is similar to the controller 40 shown in FIG. 12. At this time, as is different from the controller 40, the controller 40a supplies the C2 generation indicate signal SG3 to the predicted coordinate generator 30a in synchronization with the rising of the signal SG1.

Upon receiving the signal SG3, the predicted coordinate generator 30a generates the predicted coordinate C2 which is obtained by replicating the predicted coordinate C1 and supplies it to the window generator 10a, as shown in FIG. 2. The window generator 10a generates the window W2 having as a central phase a predicted phase P3 in the predicted coordinate C2 which is apart from the predicted phase P2 by a phase width equivalent to one frame, and supplies the window W2 to the synchronization pattern detector 21a. The window W2 has a phase width which is twice as large as the random shift phase width SW as is similar to FIG. 13.

Then, the synchronization pattern detector 21a detects the leading synchronization pattern PTN3 included in the data field F2 in the recorded data DT2 using the window W2, and supplies the synchronization detection signal SS3 to each of the predicted coordinate generator 30a and the window generator 10a. Further, the synchronization pattern detector 21a extracts the synchronization positional information INF following the synchronization pattern PTN3 to supply the synchronization positional information INF to the controller 40a, and extracts the user data UD following the synchronization positional information INF to make the demodulator 22 perform the demodulation.

Upon receiving the synchronization detection signal SS3, the window generator 10a closes the window W2. Further, the predicted coordinate generator 30a regenerates the predicted coordinate C1 to be supplied to the window generator 10a. Note that the predicted coordinate generator 30a does not regenerate the predicted coordinate C2 even when receiving the synchronization detection signal SS3.

Further, the controller 40a determines that the synchronization pattern which is to be detected next is not the leading synchronization pattern included in the data field in the following recorded data (not shown) based on the synchronization positional information INF and the user data UD, and lowers the window selection signal SG1 and the W2 generation enable signal SG2. As such, the window generator 10a generates a window W1[3] having as a central phase a predicted phase P4 in the predicted coordinate C1 which is regenerated to supply the window W1[3] to the synchronization pattern detector 21a. The synchronization pattern detector 21a detects the synchronization pattern PTN4 next to the synchronization pattern PTN3 using the window W1[3].

Hereinafter, by repeatedly executing the above operation, the synchronization detecting circuit 1a is able to obtain the user data and perform the normal synchronization detection from the reproduced signal of the HD DVD.

Further, as shown in FIG. 3, take a case where the reproduced signal RF is obtained by sequentially reproducing the recorded data DT1 and DT2 recorded in the BD as an example. In this case, the window generator 10a generates the window W1[2] having as a central phase the predicted phase P2 in the predicted coordinate C1 to supply the window W1[2] to the synchronization pattern detector 21a.

If it is assumed that the synchronization pattern PTN2 is normally recorded and reproduced, the synchronization pattern detector 21a detects the synchronization pattern PTN2 and supplies the synchronization detection signal SS2 to each of the predicted coordinate generator 30a and the window generator 10a. Further, the synchronization pattern detector 21 a extracts the synchronization positional information INF following the synchronization pattern PTN2 to supply it to the controller 40a, and extracts the user data UD following the synchronization positional information INF to make the demodulator 22 perform the demodulation.

Upon receiving the synchronization detection signal SS2, the window generator 10a closes the window W1[2]. Further, the predicted coordinate generator 30a regenerates the predicted coordinate C1 to be supplied to the window generator 10a. Furthermore, the controller 40a determines that the synchronization pattern which is to be detected next is the leading synchronization pattern included in the physical cluster area A2 in the following recorded data DT2 based on the synchronization positional information INF and the user data UD. Then, the controller 40a raises the window selection signal SG1 as is similar to when the HD DVD is reproduced. On the other hand, the controller 40a raises the W2 generation enable signal SG2 so as to generate the window W2 with the central phase of the predicted phase P4 in the predicted coordinate C2 which is apart from the predicted phase P2 by a phase width equivalent to two frames, as is different from when the HD DVD is reproduced. The window W2 has a phase width which is twice as large as the random shift phase width SW, as is similar to FIG. 2.

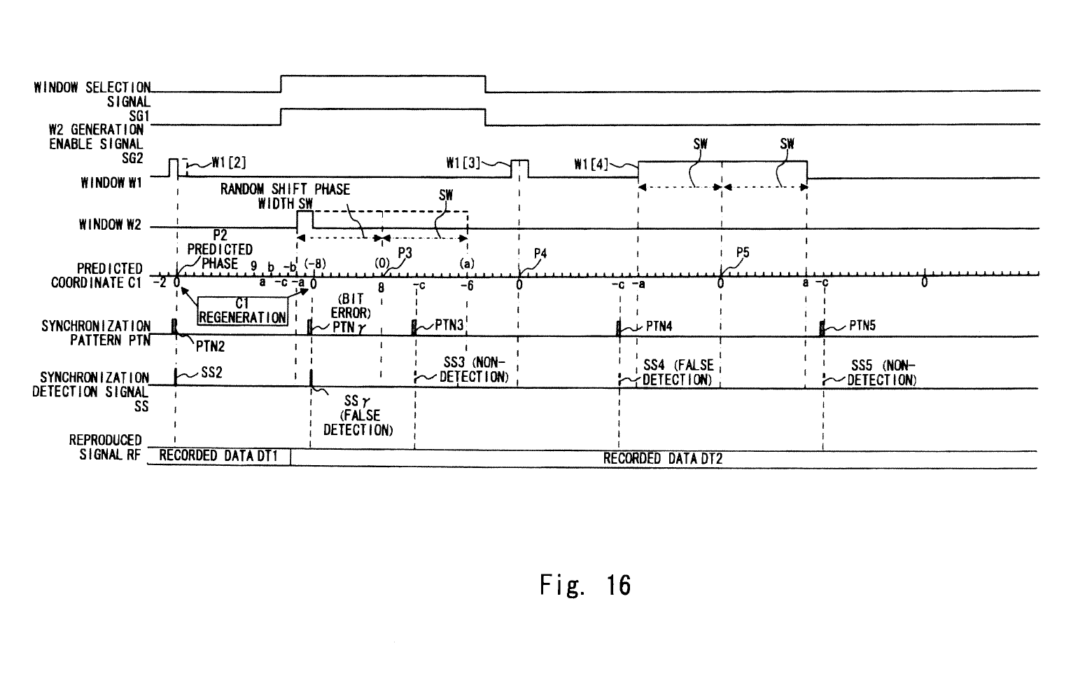

Then, the synchronization pattern detector 21a detects the leading synchronization pattern PTN3 included in the physical cluster area A2 in the recorded data DT2 using the window W2, and supplies the synchronization detection signal SS3 to the predicted coordinate generator 30a and the window generator 10a. The synchronization pattern detector 21a executes the pattern matching which is similar to that of FIG. 15. Further, the synchronization pattern detector 21a extracts the synchronization positional information INF following the synchronization pattern PTN3 to supply it to the controller 40a, and extracts the user data UD following the synchronization positional information INF to make the demodulator 22 perform the demodulation.

Upon receiving the synchronization detection signal SS3, the window generator 10a closes the window W2. Further, the predicted coordinate generator 30a regenerates the predicted coordinate C1 to be supplied to the window generator 10a. Further, the controller 40a determines that the synchronization pattern which is to be detected next is not the leading synchronization pattern included in the physical cluster area in the following recorded data (not shown) based on the synchronization positional information INF and the user data UD. Then, the controller 40a lowers the window selection signal SG1 and the W2 generation enable signal SG2. As such, the window generator 10a generates a window W1[3] having as a central phase a predicted phase P5 in the predicted coordinate C1 which is regenerated and supplies the window W1[3] to the synchronization pattern detector 21a. The synchronization pattern detector 21a detects the synchronization pattern PTN4 next to the synchronization pattern PTN3 using the window W1[3].

Hereinafter, by repeatedly executing the above operation, the synchronization detecting circuit 1a is able to obtain the user data and perform the normal synchronization detection from the reproduced signal of the BD.

### Operation Example (2)

When there is included in the window W2 generated with a center of predicted phase P3 a normal synchronization pattern PTN3 and an abnormal synchronization pattern PTNγ caused by the bit error due to scratch, dust or the like on the HD DVD or BD as shown in FIG. 4, the synchronization detecting circuit 1a falsely detects the synchronization pattern PTNγ as the normal synchronization pattern to generate a synchronization detection signal SSγ, and closes the window W2. Accordingly, the regeneration of the predicted coordinate C1 is performed, and the synchronization pattern PTN3 is not detected. Accordingly, even when the window W1[3] with a center of predicted phase P4 in the predicted coordinate C1 which is regenerated is used, the synchronization pattern PTN4 which should be detected is not detected.

However, while the window generator 10a recognizes that the synchronization pattern has been detected using the window W2 by the synchronization detection signal SSγ, it recognizes that the synchronization pattern has not been detected using the window W1[3]. As such, the window generator 10a generates the window W3 having as a central phase a predicted phase P6, for example, in the predicted coordinate C2 and having a phase width which is twice as large as the random shift phase width SW, so as to supply the window W3 to the synchronization pattern detector 21a.

The synchronization pattern detector 21a detects the synchronization pattern PTN5 next to the synchronization pattern PTN4 using the window W3, and supplies a synchronization detection signal SS5 to each of the predicted coordinate generator 30a and the window generator 10a. Upon receiving the synchronization detection signal SS5, the window generator 10a closes the window W3. Further, the predicted coordinate generator 30a regenerates the predicted coordinate C1 to be supplied to the window generator 10a.

As such, the following synchronization patterns can be detected using the window W1 or W2. Further, the two pieces of user data UD corresponding to the undetected synchronization patterns PTN3 and PTN4 can be readily restored with the subsequent error correcting circuit (not shown).

### Second Exemplary Embodiment

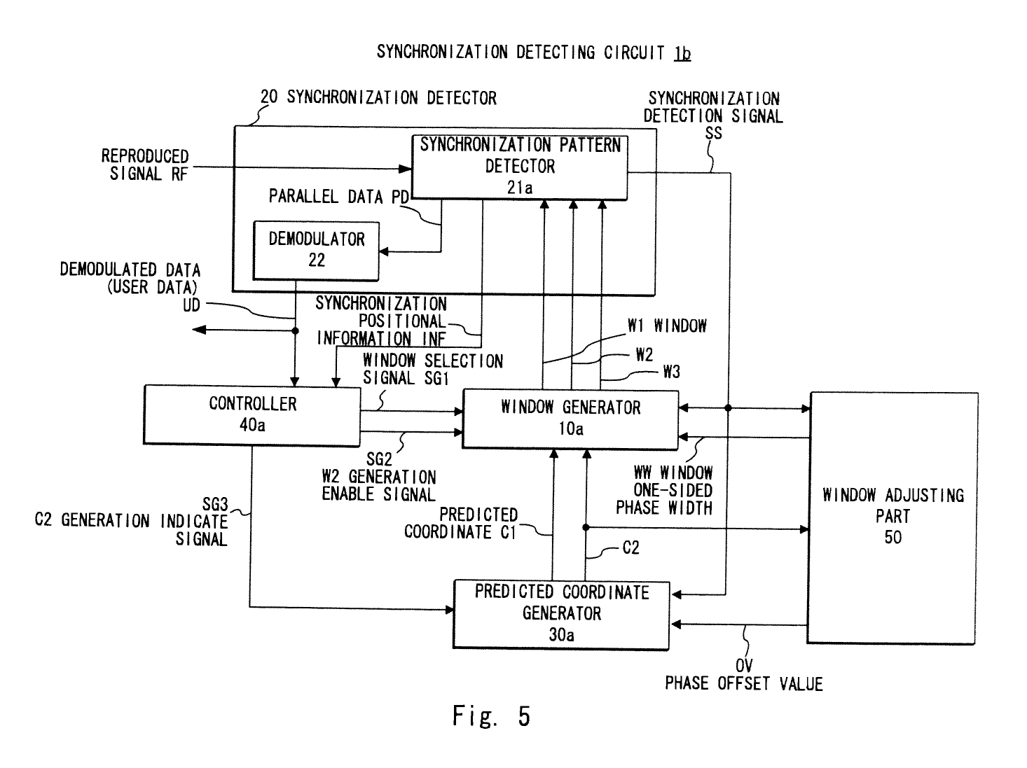

A synchronization detecting circuit 1b according to the second exemplary embodiment shown in FIG. 5 is different from the above first exemplary embodiment in that the synchronization detecting circuit 1b further includes a window adjusting part 50 in addition to the configuration of the synchronization detecting circuit 1a shown in FIG. 1. Upon detecting the synchronization pattern with the window W2, the window adjusting part 50 supplies a one-sided phase width (hereinafter referred to as window one-sided phase width) WW of the window W2 which is to be generated next to the window generator 10a to be instructed to change (narrow) the phase width of the window W2, and supplies phase offset value OV to the predicted coordinate generator 30a to be instructed to correct the predicted coordinate C2 which is to be generated next.

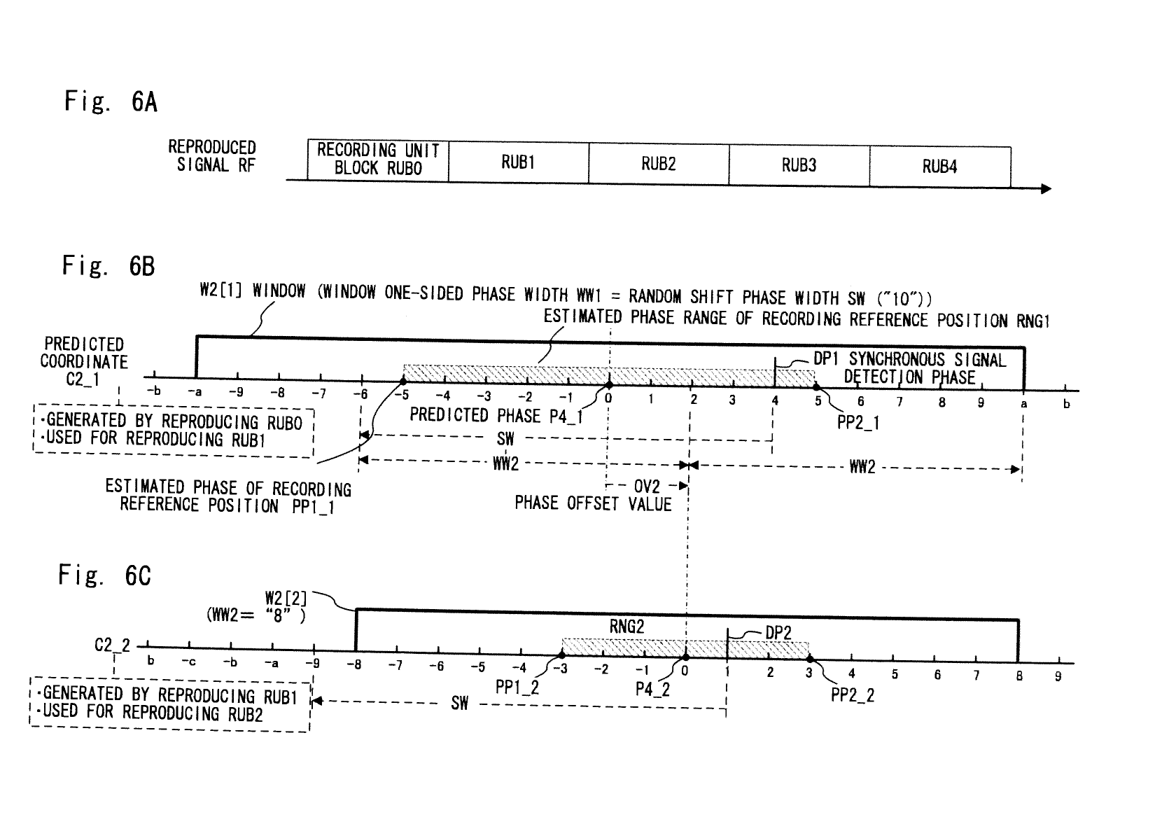

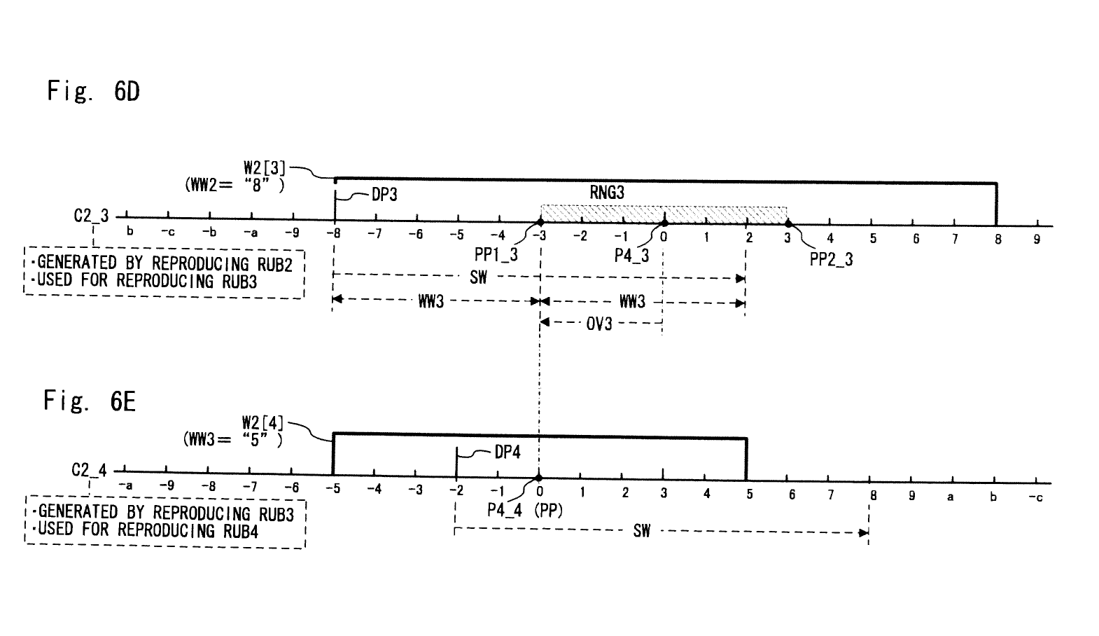

In operation, assume a case where the reproduced signal RF is obtained by sequentially reproducing five recording unit blocks RUB0 to RUB4 recorded in the BD and each subjected to random shift as shown in FIG. 6A. In the initial state, the window adjusting part 50 first supplies the window one-sided phase width WW set to the random shift phase width SW to the window generator 10a. It should be noted that the following description can be applied also to a case where the reproduced signal RF is obtained by sequentially reproducing the data segments recorded in the HD DVD.

Then, the predicted coordinate generator 30a supplies a predicted coordinate C2_1 generated by reproducing the recording unit block RUB0 as shown in FIG. 6B to each of the window generator 10a and the window adjusting part 50. The window generator 10a generates the window W2[1] (estimated phases of the recording reference position PP1_1 and PP2_1 are “−5” and “5”, respectively) having as a central phase a predicted phase P4_1 (“0”) in the predicted coordinate C2_1 and having a phase width twice as large as the random shift phase width SW (“10”) to supply the window W2[1] to the synchronization pattern detector 21a. Further, the synchronization pattern detector 21a detects the leading synchronization pattern of the physical cluster area in the recording unit block RUB1 using the window W2[1] to generate the synchronization detection signal SS.

Now, when it is assumed that the leading synchronization pattern is detected at the phase “4” in the window W2[1], the window adjusting part 50 receiving the synchronization detection signal SS recognizes the phase “4” as the detection phase DP1 of the synchronous signal.

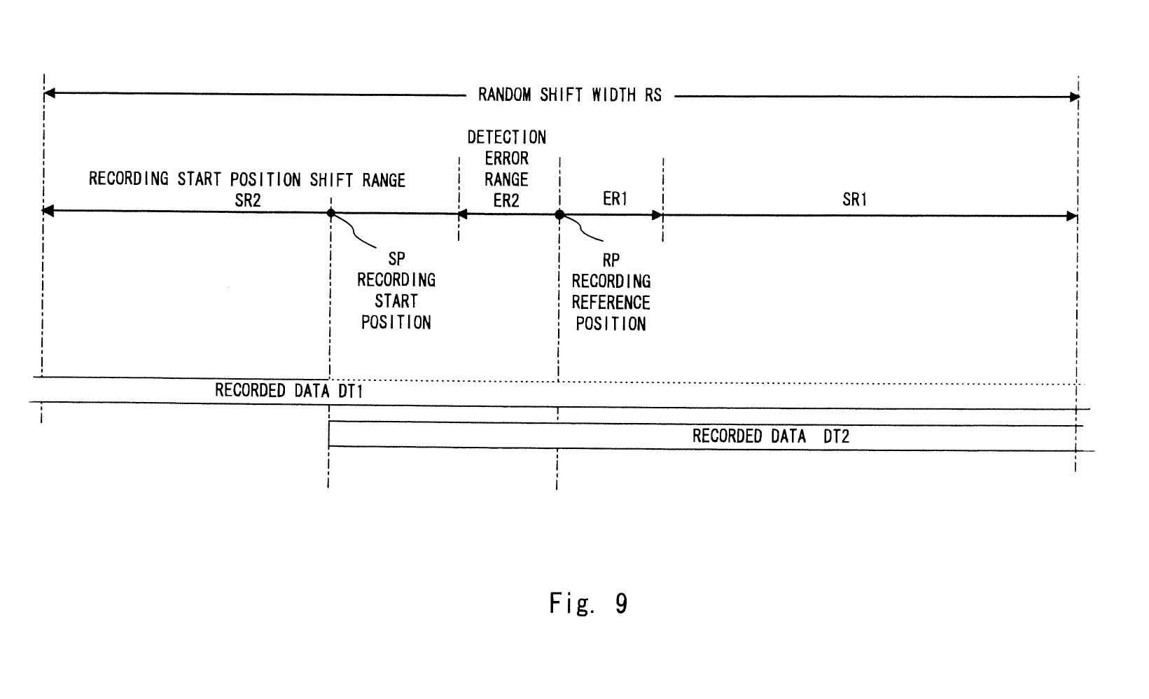

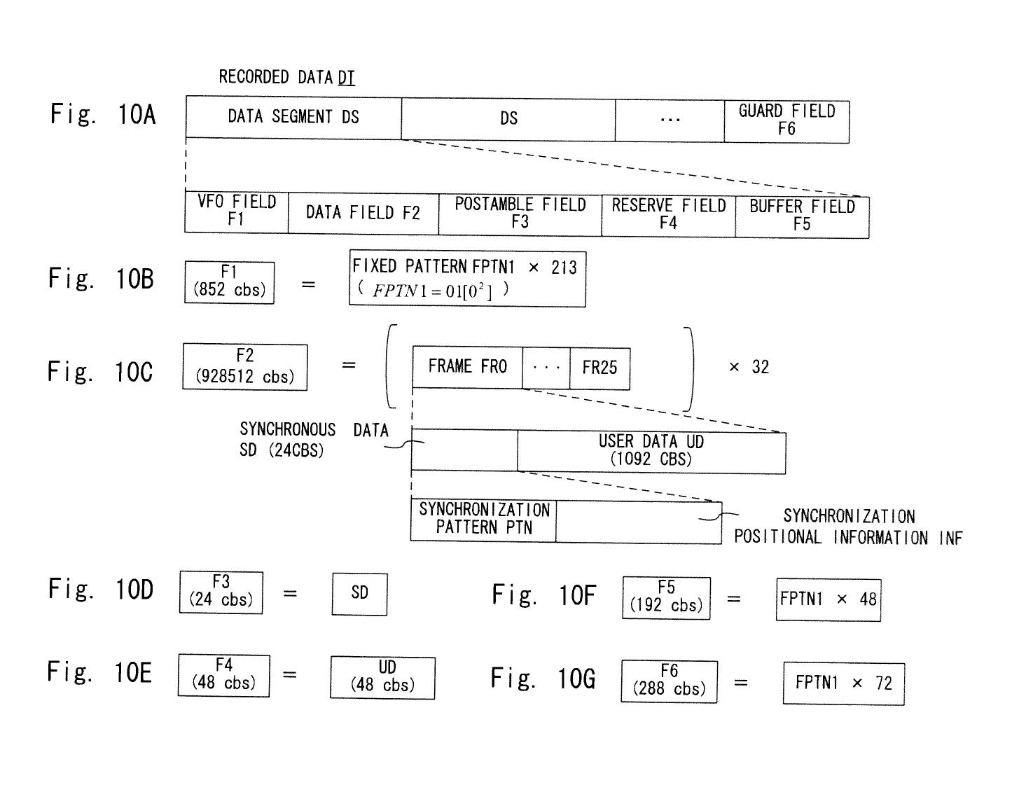

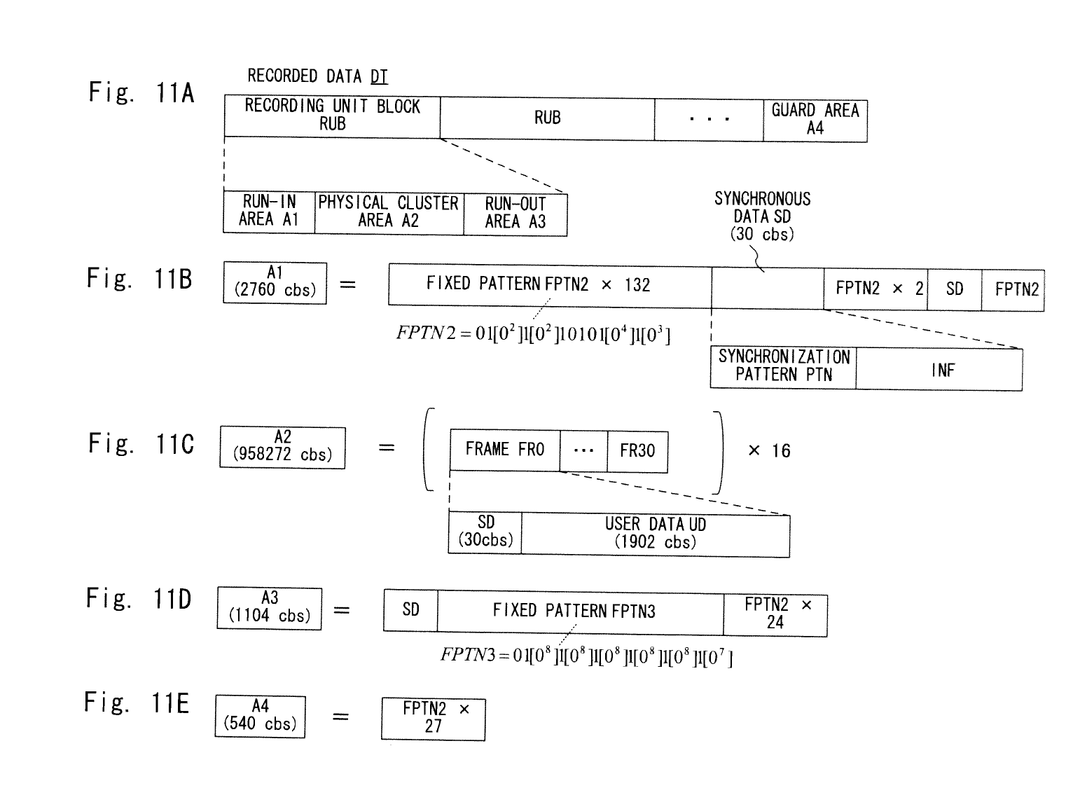

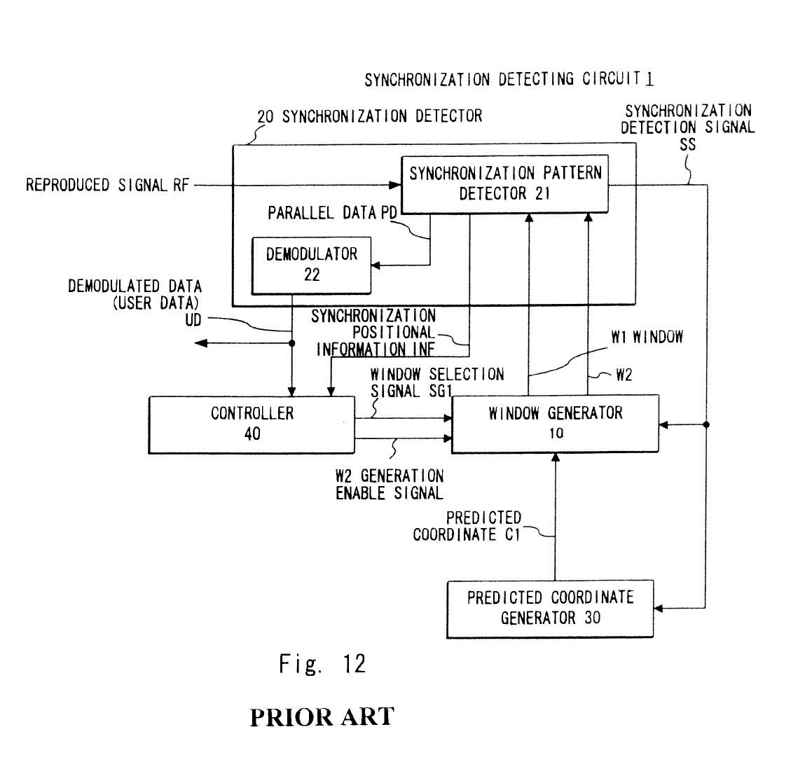

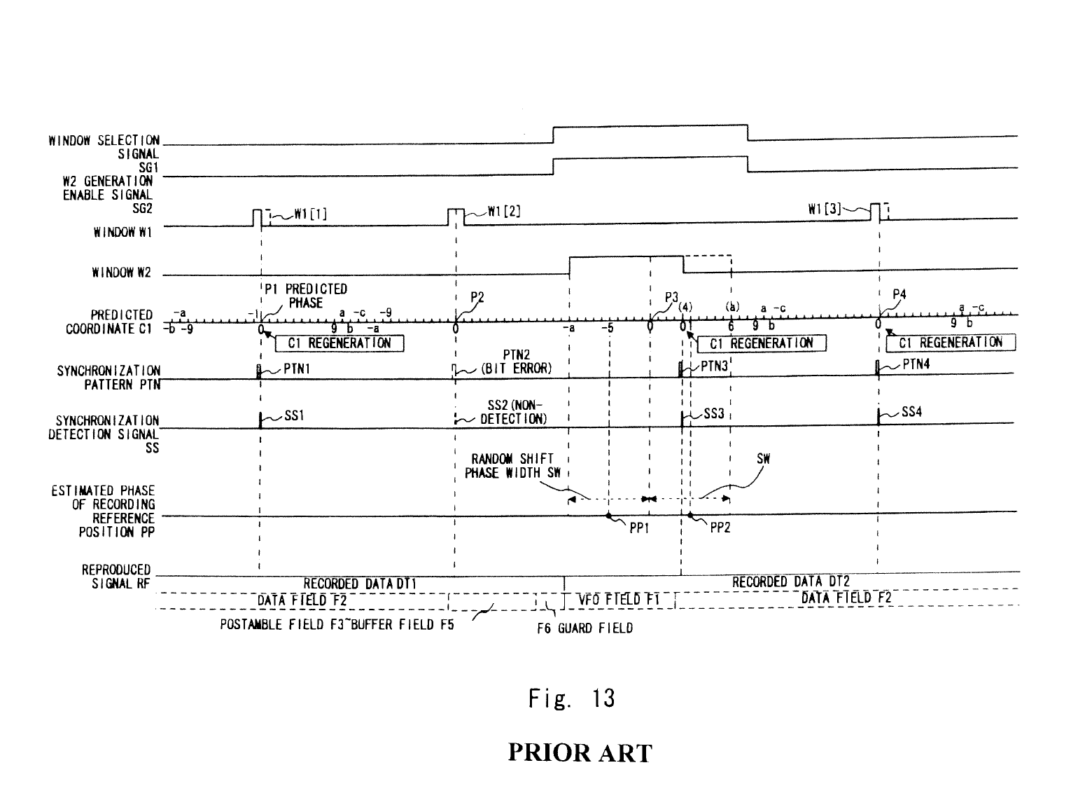

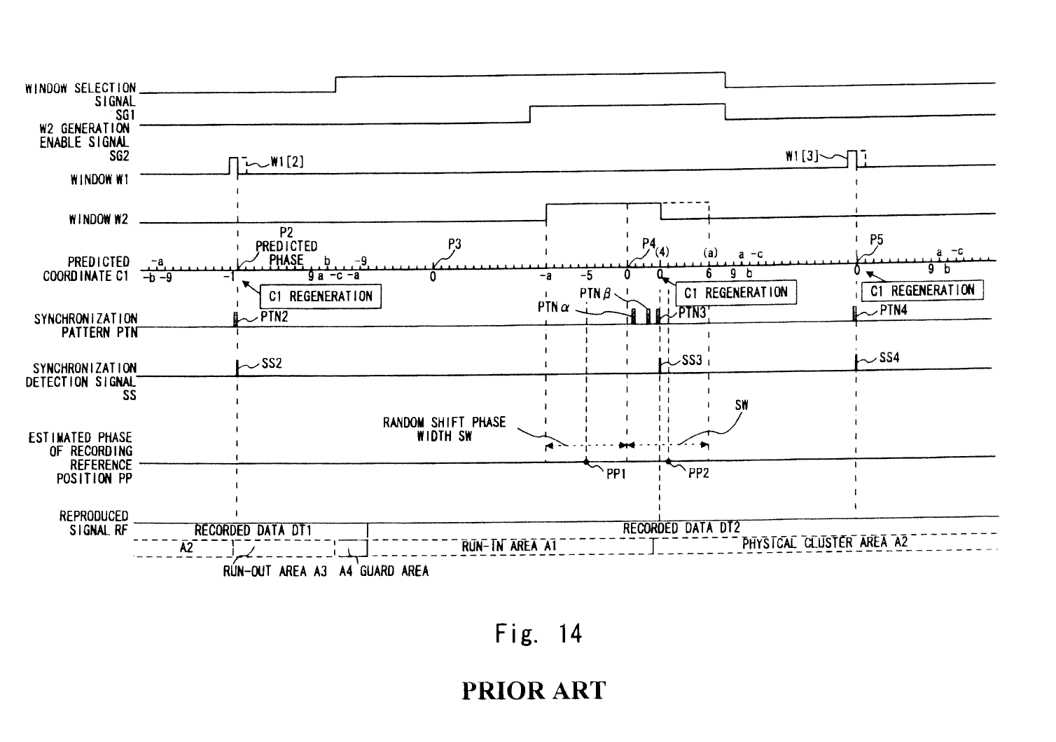

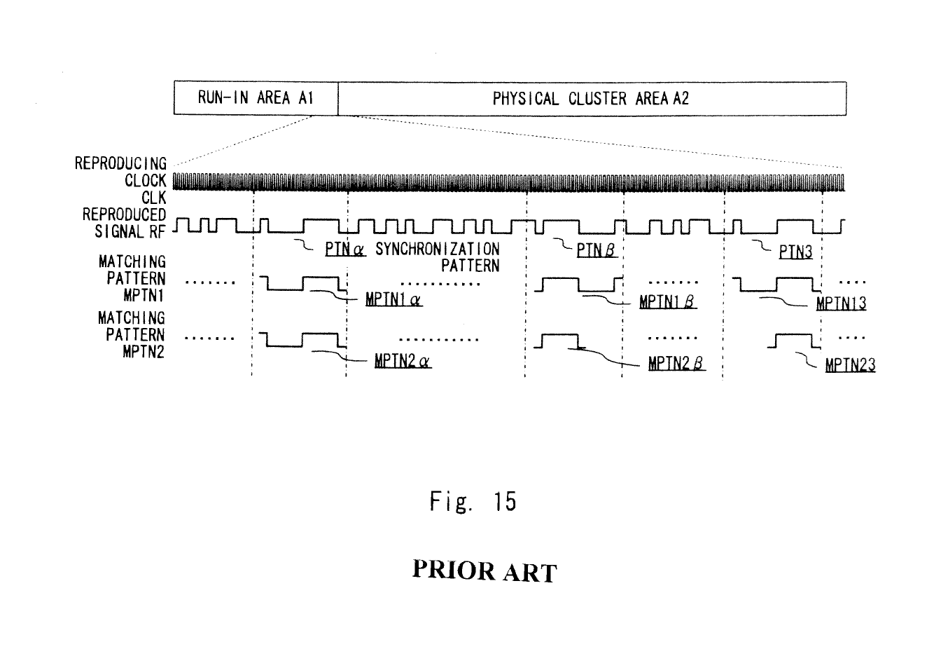

As described above, even when the recording start position SP (see FIG. 9) of the recording unit block RUB1 is shifted to the right end of the recording start position shift range SR1 with respect to the recording reference position RP, the synchronous signal detection phase DP1 definitely exists within the random shift phase width SW with a center of estimated phase PP1_1. In other words, as the detection phase DP1 is “4”, the estimated phase PP1_1 is limited to “−1”, whereby the estimated phase range RNG1 of the recording reference position can be narrowed by the phase width “4” (which means that the phase width of the window W2 can be narrowed by “4”).

As such, when the detection phase DP>“0” (when the detection phase DP is advanced with respect to the predicted phase P4), the window adjusting part 50 calculates the optimal one-sided phase width OW of the window W2 by the following expression (1).

OW={|DP−SW|+WW}/2 (1)

The above expression (1) shows that half the phase width between the phase which is apart from the detection phase DP by the random shift phase width SW in a direction of the predicted phase P4 and the end phase in the detection phase DP side of the window W2 is set to the optimal one-sided phase width OW. When the detection phase DP1 (“4”), the window one-sided phase width WW1 (“10”), and the random shift phase width SW (“10”) shown in FIG. 6B are substituted into the above expression (1), the optimal one-sided phase width OW=“8”((“6”+“10”)/2) can be obtained.

The window adjusting part 50 supplies to the window generator 10a this optimal one-sided phase width OW=“8” as the one-sided phase width WW2. As such, as shown in FIG. 6C, the window W2[2] which is to be generated next is made narrower than the window W2[1] by the phase width “4” (“20”−“16”).

The window adjusting part 50 calculates the phase offset value OV by the following expression (2).

OV={(DP−SW)+WW}/2 (2)

The above expression (2) shows the intermediate phase between the end phase in the detection phase DP side of the window W2 and the phase which is apart from the detection phase DP by the random shift phase width SW in a direction of the predicted phase P4. When the detection phase DP1 (“4”), the window one-sided phase width WW1 (“10”), and the random shift phase width SW (“10”) shown in FIG. 6B are substituted into the above expression (2), the phase offset value OV2=“2” ((“−6”+“10”)/2) can be obtained.

The window adjusting part 50 supplies this phase offset value OV2=“2” to the predicted coordinate generator 30a. As such, as shown in 6C, the predicted coordinate C2_2 which is to be generated next is advanced from the coordinate which is obtained by replicating the predicted coordinate C1 by the phase “2”.

Then, the synchronization pattern detector 21a detects the leading synchronization pattern of the physical cluster area in the recording unit block RUB2 using the window W2[2] to generate the synchronization detection signal SS.

Now, assume a case in which the leading synchronization pattern is detected at the phase “1” in the window W2[2]. Then, upon receiving the synchronization detection signal SS, the window adjusting part 50 recognizes the phase “1” as the detection phase DP2 of the synchronous signal. In this case, as there is a phase (“−9”) which is apart from the detection phase DP2 (“1”) by the random shift phase width SW in a direction of predicted phase P4_2 outside of the window W2[2], the window adjusting part 50 determines that the calculation of the optimal one-sided phase width OW and the phase offset value OV is not needed, and no more processing is performed.

Then, the synchronization pattern detector 21a detects, as shown in FIG. 6D, the leading synchronization pattern of the physical cluster area in the recording unit block RUBS using the window W2[3] having the same phase width as the window W2[2] to generate the synchronization detection signal SS.

Assume a case in which the leading synchronization pattern is detected at the phase “−8” in the window W2[3]. Then, upon receiving the synchronization detection signal SS, the window adjusting part 50 recognizes the phase “−8” as the detection phase DP3 of the synchronous signal. In this case, as there is a phase (“2”) which is apart from the detection phase DP3 by the random shift phase width SW in a direction of predicted phase P4_3 in the window W2[3], the window adjusting part 50 determines that the calculation of the optimal one-sided phase width OW and the phase offset value OV is possible.

When the detection phase DP<“0” (when the detection phase DP is delayed with respect to the predicted phase P4), the window adjusting part 50 calculates the optimal one-sided phase width OW by the following expression (3) and calculates the phase offset value OV by the following expression (4).

OW={WW+(DP+SW)}/2 (3)

OV={−WW+(DP+SW)}/2 (4)

When the detection phase DP3 (“−8”), the window one-sided phase width WW2 (“8”), and the random shift phase width SW (“10”) shown in FIG. 6D are substituted into each of the above expressions (3) and (4), the optimal one-sided phase width OW=“5”((“8”+“2”)/2) and the phase offset value OV3=“−3”((“−8”+“2”)/2) can be obtained.

The optimal one-sided phase width OW (“5”) means that, as shown in FIG. 6E, the phase width of the window W2[4] which is to be generated next is equal to the random shift phase width SW. Further, the phase offset value OV3 (“−3”) means the estimated phase of the recording reference position uniquely specified.

When reproducing the recording unit block RUB4 and the following recording unit blocks, the leading synchronization pattern of the physical cluster area is detected using the window W2 in accordance with the optimal one-sided phase width OW(“5”) and the phase offset value OV3 (“−3”). Accordingly, in the second exemplary embodiment, the false detection of the abnormal synchronization pattern caused by the bit error due to scratch, dust or the like on the recording medium can be reduced compared with the first exemplary embodiment.

In the second exemplary embodiment, although the optimization processing of the window W2 is executed when the synchronization pattern is detected using the window W2, this optimization processing can also be executed when the synchronization pattern is detected using the window W1.

This is because the synchronization pattern following the leading synchronization pattern of the physical cluster area (or data field in the HD DVD) periodically appears. In other words, the phase difference=“4” between the detection phase “4” on the predicted coordinate C2 of the synchronization pattern PTN4 detected using the window W1[3] shown in FIG. 3 and the predicted phase “0” in the predicted coordinate C2 that is proximal to the detection phase “4” is equal to the phase difference=“4” between the detection phase “4” of the synchronization pattern PTN3 detected using the window W2 and the predicted phase P4 (“0”). Accordingly, by using the detection phase on the predicted coordinate C2 of the synchronization pattern detected using the window W1 as the synchronous signal detection phase DP in the above expressions (1) to (4), the optimal one-sided phase width OW of the window W2 which is to be generated next and the phase offset value OV of the predicted coordinate C2 which is to be generated next can be calculated similarly.

### Third Exemplary Embodiment

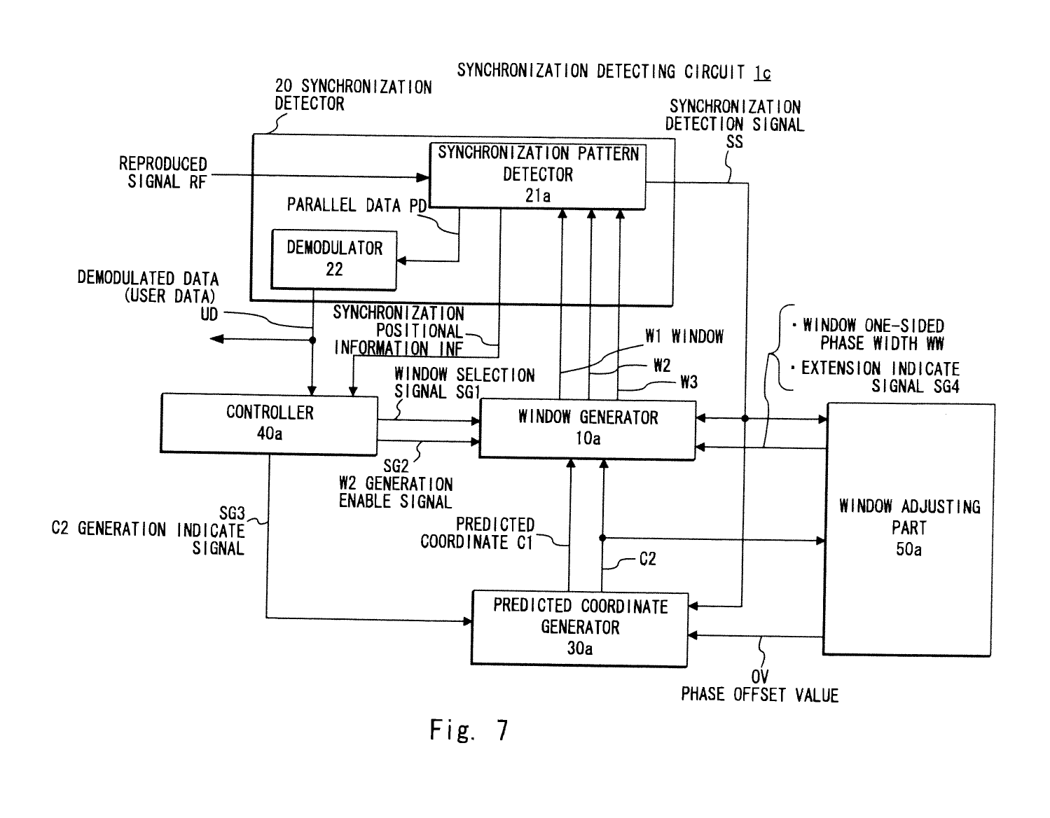

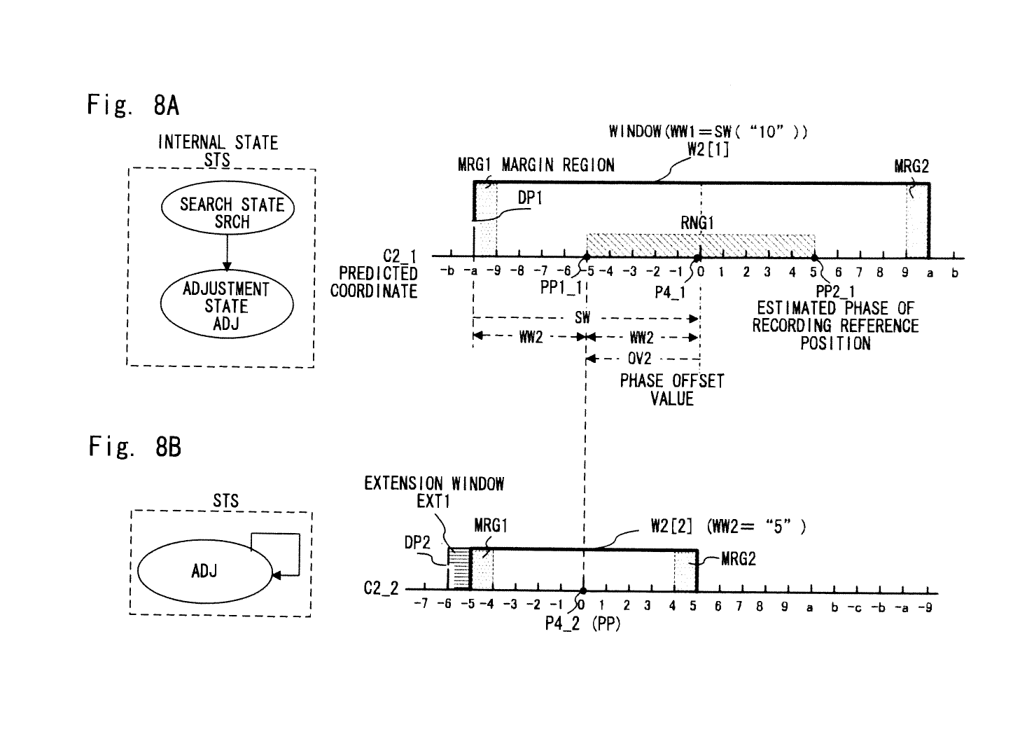

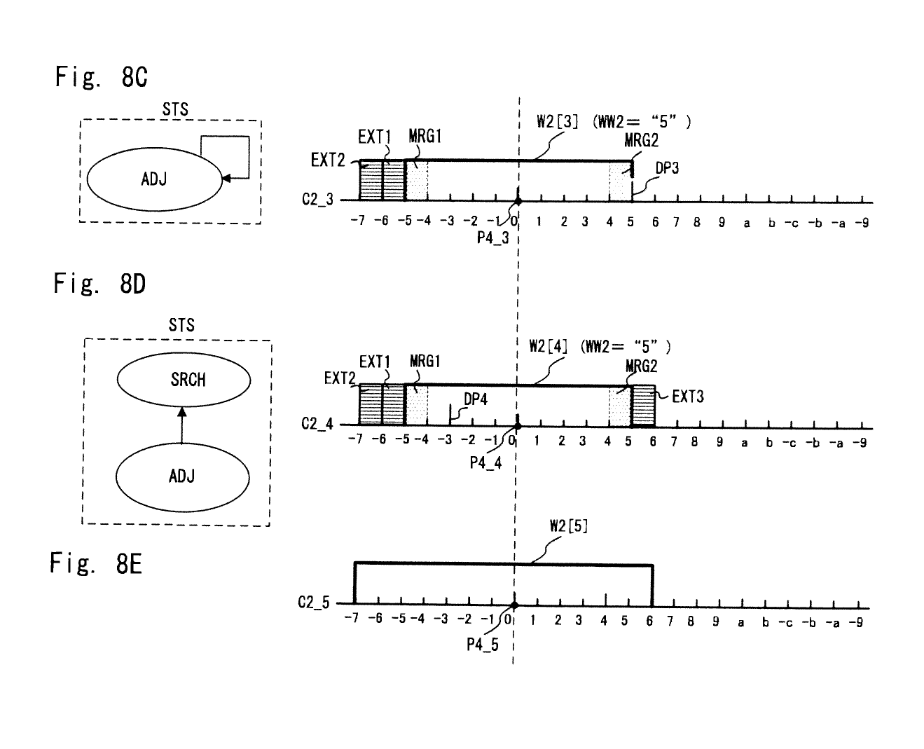

A synchronization detecting circuit 1c according to the third exemplary embodiment shown in FIG. 7 is different from the above second exemplary embodiment in that the window adjusting part 50a supplies a signal instructing the extension of the window W2 (hereinafter referred to as extension indicate signal) SG4 to the window generator 10a in addition to the window one-sided phase width WW. The window adjusting part 50a manages, as shown in FIGS. 8A to 8D, an internal state STS that transits between a search state SRCH in which the optimization processing of the window W2 shown in the second exemplary embodiment is executed and an adjustment state ADJ in which the extension processing of the window W2 in the third exemplary embodiment is executed.

According to the synchronization detecting circuit 1 c, the disturbance of the reproducing clock (not shown) generated from the former PLL circuit (not shown) or the like can be addressed. In general, the PLL circuit forces to generate the reproducing clock even when the reproduced signal RF cannot be obtained due to scratch, dust or the like on the recording medium. As such, the frequency of the reproducing clock may be disturbed with respect to the reproduced signal RF. In this case, the synchronization pattern PTN cannot be accurately detected in the window W2.

In operation, it is assumed that the internal state STS is set to the search state SRCH, and the synchronous signal detection phase DP1 (“−a”) is obtained using the window W2[1] as shown in FIG. 8A. In this case, the window adjusting part 50a first calculates the optimal one-sided phase width OW (window one-sided phase width WW2)=“5” and the phase offset value OV2=“−5” by the above expressions (3) and (4), whereby the window generator 10a and the predicted coordinate generator 30a perform the optimization of the window W2.

Then, the window adjusting part 50a determines whether or not there is detection phase DP1 in margin regions MRG1 and MRG2 defined by a certain phase width (“1”, in this example) from both end phases (“−a” and “a”) of the window W2[1] (in other words, whether or not there is disturbance in the reproducing clock). Now, the detection phase DP1 is determined to be in the margin region MRG1. Therefore, the window adjusting part 50a supplies the extension indicate signal SG4 to the window generator 10a to extend the window W2 by a predetermined phase width (“1” in this example) to the detection phase DP1 side, and transits the internal state STS to the adjustment state ADJ.

Upon receiving the extension indicate signal SG4, the window generator 10a generates the window W2[1] having as a central phase a predicted phase 4_2 in the predicted coordinate 2_2 and having a phase width equal to the random shift phase width SW, and opens an extension window EXT1 between the phases “−6” to “−5” in the predicted coordinate 2_2 as shown in FIG. 8B.

Then, the window adjusting part 50a determines whether or not there is a synchronous signal detection phase DP2 (“−6”) in the extension window EXT1. Now, it is determined that there is the detection phase DP2 in the extension window EXT1. Therefore, the window adjusting part 50a supplies the extension indicate signal SG4 to the window generator 10a to further extend the window W2 to the detection phase DP2 side. Upon receiving the extension indicate signal SG4, the window generator 10a further opens, as shown in FIG. 8C, an extension window EXT2 between the phases “−7” to “−6” in the predicted coordinate 2_3.

Further, when it is assumed that a synchronous signal detection phase DP3 (“5”) has been obtained in the margin region MRG2, the window adjusting part 50a supplies the extension indicate signal SG4 to the window generator 10a to further extend the window W2 to the detection phase DP3 side. Upon receiving the extension indicate signal SG4, the window generator 10a opens, as shown in FIG. 8D, an extension window EXT3 between the phases “5” to “6” in the predicted coordinate 2_4.

On the other hand, when it is assumed that a synchronous signal detection phase DP4 (“−3”) is obtained outside of the margin regions MRG1 and MRG2 of the window W2[4], the window adjusting part 50a determines that the disturbance of the reproducing clock has been canceled, and supplies the window one-sided phase width WW to the window generator 10a so that the phase width of the window W2[5] which is to be generated next becomes the total phase width “13”(“10”+“1”+“1”+“1”) of the window W2[4] and the extension windows EXT1 to EXT3 as shown in FIG. 8E. Further, the window adjusting part 50a transits the internal state STS to the search state SRCH. Accordingly, the optimization processing of the window W2 is executed again.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

The first to third exemplary embodiments can be combined as desirable by one of ordinary skill in the art. Atty. What is claimed is:

1. A synchronization detecting method, comprising:
generating a first window for detecting a synchronous signal having as a central phase each predicted phase in a first coordinate when it is determined that a synchronous signal to be detected next is not a leading synchronous signal included in a data area of one data block based on a data signal following the synchronous signal and synchronization positional information included in each synchronous signal that repeatedly appears in a reproduced signal of a recording medium where a method is employed of randomly shifting a recording start position within a certain width with respect to a predetermined recording reference position every time one or more data blocks formed of a header area, a data area, and a footer area are recorded;
generating a second coordinate obtained by replicating the first coordinate and generating a second window for detecting the synchronous signal having as a central phase a first predicted phase selected from predicted phases in the second coordinate based on area length of the footer area and the header area and having a phase width equivalent to twice the certain width when it is determined that the synchronous signal to be detected next is the leading synchronous signal;
generating a third window for detecting the synchronous signal having as a central phase one predicted phase in the second coordinate and having a phase width equivalent to twice the certain width when the synchronous signal is not detected using the first window after the synchronous signal is detected using the second window, wherein the first coordinate indicates a predicted phase of each synchronous signal to be subsequently appeared based on periodicity of the synchronous signal every time the synchronous signal is detected; and
performing window adjustment that determines whether the detection phase of the synchronous signal on the second coordinate is deviated from a nearest predicted phase in the second coordinate when the synchronous signal is detected using the first window, and when the detection phase is determined to be deviated from the nearest predicted phase, narrows a phase width of a second window to be generated next based on the detection phase, a phase width equivalent to the certain width, and the phase width of the second window and corrects a second coordinate to be generated next.

2. The synchronization detecting method according to claim 1 further comprising changing the phase width of the second window to be generated next to a phase width between a first phase that is apart from the nearest predicted phase by half the phase width of the second window in the detection phase side and a second phase that is apart from the detection phase by the phase width equivalent to the certain width in a direction of the nearest predicted phase, and offsetting the second coordinate to be generated next in a deviation direction of an intermediate phase between the first and second phases with respect to the nearest predicted phase by deviation amount in performing the window adjustment.

3. A synchronization detecting circuit, comprising:
a window generator that generates a window;
a synchronization detector that sequentially detects synchronous signals that repeatedly appear in a reproduced signal of a recording medium where a method is employed of randomly shifting a recording start position within a certain width with respect to a predetermined recording reference position every time one or more data blocks formed of a header area, a data area, and a footer area are recorded using the window, and obtains synchronization positional information included in the synchronous signal and a data signal following the synchronous signal;
a predicted coordinate generator that generates a first coordinate indicating a predicted phase of each synchronous signal to be subsequently appeared based on periodicity of the synchronous signal every time the synchronous signal is detected;
a controller that makes the window generator generate a first window having as a central phase each predicted phase in the first coordinate when it is determined that a synchronous signal to be detected next is not a leading synchronous signal included in a data area of one data block based on the synchronization positional information and the data signal, and makes the predicted coordinate generator generate a second coordinate obtained by replicating the first coordinate and makes the window generator generate a second window having as a central phase a first predicted phase selected from predicted phases in the second coordinate based on area length of the footer area and the header area and having a phase width equivalent to twice the certain width when it is determined that the synchronous signal to be detected next is the leading synchronous signal, wherein the window generator generates a third window having as a central phase one predicted phase in the second coordinate and having a phase width equivalent to twice the certain width when the synchronous signal is not detected using the first window after the synchronous signal is detected using the second window by the synchronization detector; and
a window adjusting part that determines whether the detection phase of the synchronous signal on the second coordinate is deviated from a nearest predicted phase in the second coordinate when the synchronous signal is detected using the first window, and when the detection phase is determined to be deviated from the nearest predicted phase, instructs the window generator to narrow a phase width of a second window to be generated next based on the detection phase, a phase width equivalent to the certain width, and the phase width of the second window, and instructs the predicted coordinate generator to correct a second coordinate to be generated next.

4. The synchronization detecting circuit according to claim 3, wherein the window adjusting part instructs the window generator to change the phase width of the second window to be generated next to a phase width between a first phase that is apart from the nearest predicted phase by half the phase width of the second window in the detection phase side and a second phase that is apart from the detection phase by the phase width equivalent to the certain width in a direction of the nearest predicted phase, and instructs the predicted coordinate generator to offset the second coordinate to be generated next in a deviation direction of an intermediate phase between the first and second phases with respect to the nearest predicted phase by deviation amount.
